(19) United States
(12) Patent Application Publication
(10) Pub. No.: US 2024/0123587 A1
(43) Pub. Date: Apr. 18, 2024

(54) Fin Removal Tool With Integrated Brush

(71) Applicant: CLEANFIN LLC, DOVER, DE (US)

(72) Inventor: David Alexander Gal, Caesarea (IL)

(21) Appl. No.: 18/361,505

(22) Filed: Jul. 28, 2023

Related U.S. Application Data
(60) Provisional application No. 63/393,434, filed on Jul. 29, 2022.

(51) Int. Cl. B25B 27/14; A46B 15/00; B25G 1/08; B63B 32/70; B63B 59/06

(52) U.S. Cl. CPC B25B 27/14; A46B 15/0055; B25G 1/085; B63B 32/70; B63B 59/06; A46B 2200/1006; A46B 2200/3073

(57) ABSTRACT

A surfboard multitool has a handle with a fin key or screwdriver inserted into one end for storage, and the other end terminating in a brush on the front side and a fin removal tool on the back side. The fin removal tool has two fin grippers that are placed around a surfboard fin in use, and pivoted to remove the fin from its fin box. A fin key or screwdriver is stored in the end of the handle. Between the fin removal tool, brush, and removable fin key or screwdriver, an all-in-one multitool for the most regular tasks in surfboard maintenance is provided.

### RELATED APPLICATION

This application claims priority to U.S. Provisional Patent Application Ser. No. 63/393,434 for a “Fin Removal Tool With Integrated Brush,” filed Jul. 29, 2022, and currently co-pending, the entirety of which is incorporated herein by this reference.

### FIELD OF THE INVENTION

The present invention pertains generally to surfboard maintenance. More particularly, the present invention provides a multitool particularly, but not exclusively, useful as a brush and fin removal tool for surfboards.

### BACKGROUND OF THE INVENTION

Surfing is a popular pastime in coastal regions and traditionally involves standing on a surfboard while being carried or propelled by ocean waves. Surfboards require regular maintenance, including cleaning, waxing, and repairing cracks and dings, for both safety in use and maximizing the board's lifetime.

Modern surfboards have fins, which provide greater stability and control to the surfer, and improve performance. Surfboards commonly have between one and three fins, and sometimes more. Although fins are sometimes laminated into the surfboard itself (“glassed-in”), it is common for fins to be removably installed in “fin boxes,” which are apertures in the surfboard designed to receive and hold in place fins. Removable fins provide the advantage of easy maintenance and the ability for the surfer to try out different types of fins.

Removable surfboard fins need to be pivoted or rotated into place, and often require enough force for installation or removal that it is uncomfortable to do so bare-handed. Moreover, some types of fins also require screws to hold them in place, thus requiring a screwdriver for installation and removal. In many cases, a small screw specifically made for surfboard fins is used, and requires a “fin key” rather than a standard screwdriver.

In view of the above, it would be advantageous to provide a tool for removing surfboard fins with features for tightening and loosening fin screws and for cleaning the surfboard and fins.

### SUMMARY OF THE INVENTION

Disclosed is a fin removal tool with an integrated brush. The tool includes a head with fin grippers on one side to facilitate fin removal, and a brush on the other side. A handle extends from the head to allow a user to grip and manipulate the tool easily. In a preferred embodiment, a removable fin key or other tool is stored in the end of the handle. When the fin key or other tool stored in the handle is needed, it can be pulled out of the handle for use. When finished using the fin key or other tool, the user pushes it back into the handle until it snaps into place, locking it into the handle until it is needed again. A nylon cord or other link or ring attachment on the end of the handle facilitates both removal of the fin key and carrying of the tool.

In use, the fin removal tool is positioned over a fin mounted on a surfboard and slid down so that the fin grippers partially encircle the fin. The tool is then pivoted, pulling the fin out of the surfboard's fin box. However, some surfboard fins are fastened to the surfboard with a screw; in such cases, the screw is removed using the removable tool stored in the handle prior to using the fin removal tool as described above.

The brush is useful for cleaning the surfboard, and particularly for sand removal, thus facilitating maintenance and improving the lifespan of the surfboard. The brush is also useful for cleaning off sand from the user, especially the user's hands and feet, after leaving the beach and entering a car. Between the fin removal tool, brush, and removable fin key or screwdriver, an all-in-one multitool for the most regular tasks in surfboard maintenance is provided.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a front perspective view of a preferred embodiment of a fin removal tool with an integrated brush;

FIG. 2 is a rear perspective view of a preferred embodiment of a fin removal tool and brush illustrating the removal of a handle insert containing an additional tool;

FIG. 3 is a perspective view of an alternate preferred embodiment of a fin removal tool and brush illustrating the components of the fin removal tool in greater detail;

FIG. 4 is a rear view of the alternate preferred embodiment of a fin removal tool with an integrated brush;

FIG. 5 is a rear view of a preferred embodiment of a fin removal tool with an integrated brush illustrating use of the fin removal tool for removing a fin from a surfboard;

FIG. 6 is a perspective view of a removable driver tool from the handle of a preferred embodiment of a fin removal tool with an integrated brush;

FIG. 7 is a diagram of the internal structure of a removable driver tool from the handle of a fin removal tool and brush;

FIG. 8 is a perspective view of a preferred embodiment of a removable driver tool from the handle of a fin removal tool with an integrated brush.

### DETAILED DESCRIPTION

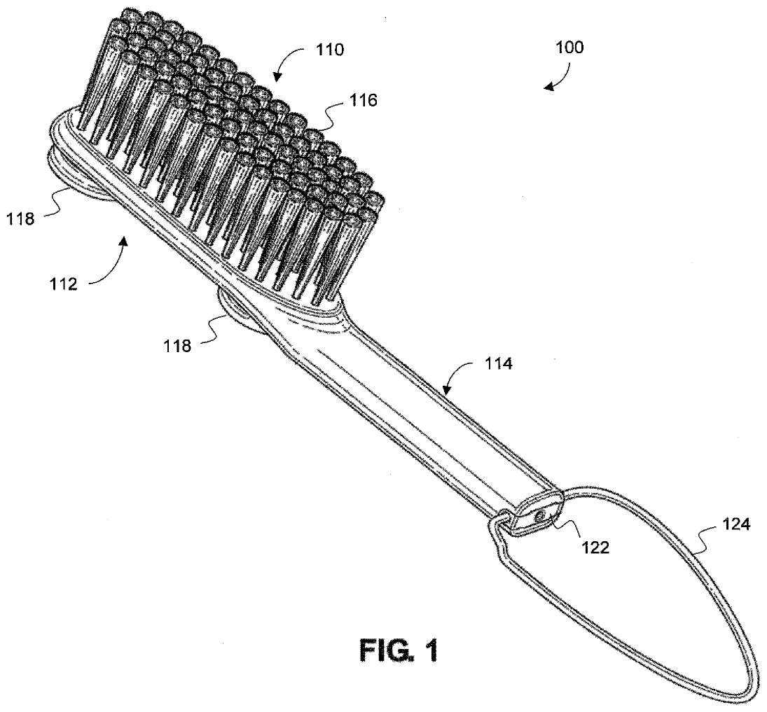

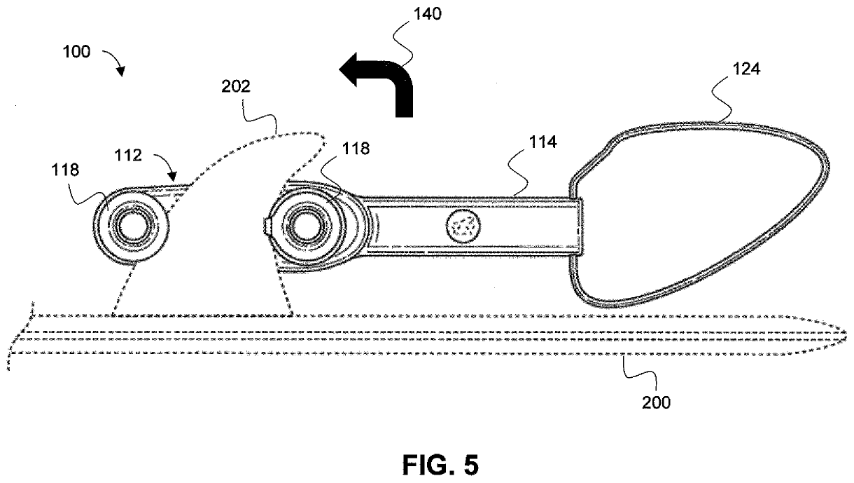

Referring initially to FIG. 1, a preferred embodiment of a fin removal tool with a brush is illustrated and generally designated 100. Tool 100 has a brush 110 and a fin removal tool 112 on its top end, with brush 110 in front and fin removal tool 112 opposite brush 110 on the rear side. Extending from brush 110 and fin removal tool 112 and integral with tool 100 is handle 114. Brush 110 contains bristles 116. Fin removal tool 112 includes two fin grippers 118 that are placed on either side of a surfboard fin in use (illustrated further in FIG. 5).

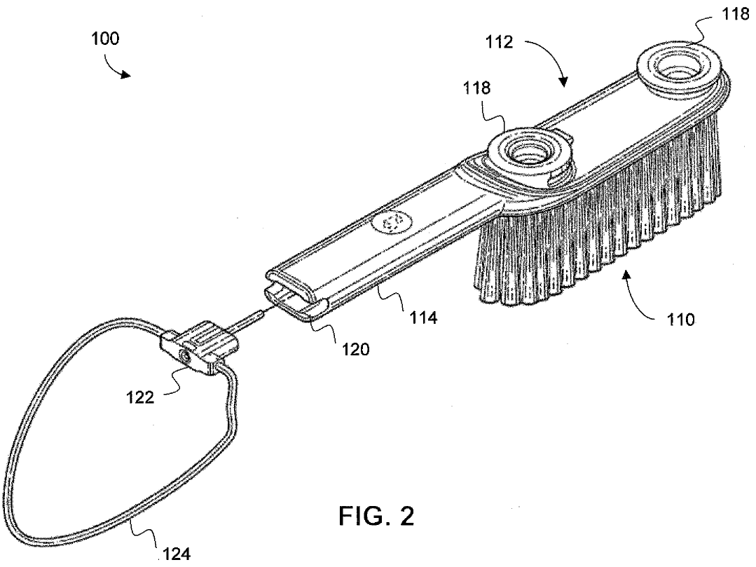

On the bottom end of handle 114 is an aperture 120 (shown in FIG. 2) into which a removable fin key 122 is inserted. A nylon cord 124, about four (4) millimeters in diameter in a preferred embodiment, is attached to the fin key 122 in preferred embodiments to facilitate removal of fin key 122 from handle 114 and for convenience in carrying tool 100 or fin key 122 when separated from tool 100.

Referring now to FIG. 2, fin key 122 is illustrated in a removed state apart from handle 114 of tool 100. A user removes fin key 122 by pulling it out from handle 114. A preferred method of removal involves grasping handle 114 with one hand, and pulling out fin key 122 with the other hand via nylon cord 124. After use, fin key 122 is reinserted into handle 114 until it snaps into place.

In a preferred embodiment, fin key 122 is replaceable with other tools such as a (“slot” or “flathead”) screwdriver, a Phillips-head screwdriver, or another tool.

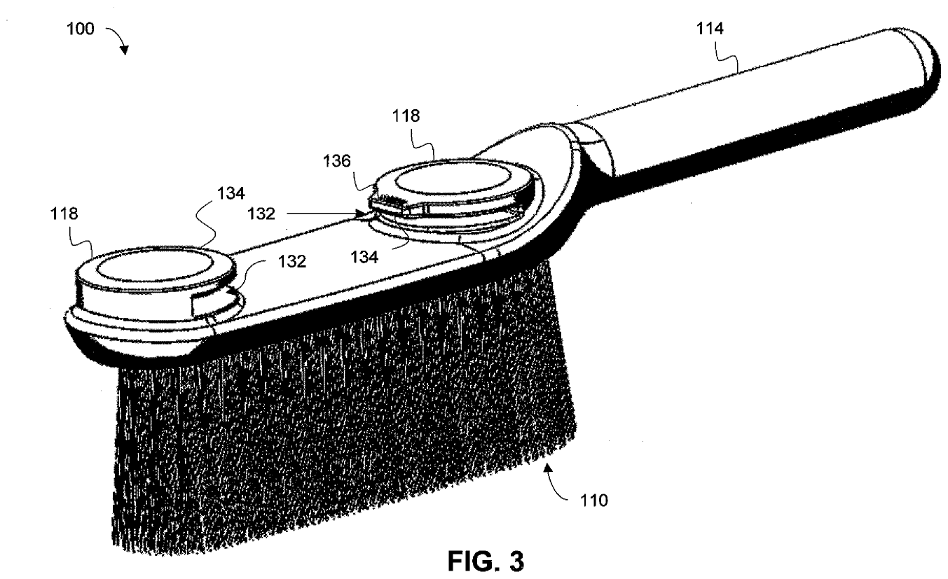

Referring now to FIG. 3, an alternate preferred embodiment of fin removal tool with integrated brush 100 is illustrated. It will be apparent to a person of ordinary skill in the art that the tool 100 as illustrated in FIG. 3 has many features in common with the embodiment of tool 100 illustrated in FIGS. 1 and 2. Moreover, additional embodiments including the various possible combinations of features present in the illustrated and described embodiments are fully contemplated herein.

Fin removal tool 112 has two fin grippers 118 spaced sufficiently apart from each other to be placed snugly around a surfboard fin. In order to engage the fin so as to enable its removal by the tool 112, each fin gripper 118 has an indentation 132 below its upper portion 134. Upper portion 134 is generally cylindrical, as is the shape of fin gripper 118 generally when disregarding its indentation 132, but has an indentation through its center in some embodiments.

In preferred embodiments, the first fin gripper 118 is located at or proximate the top of tool 100 and the second fin gripper 118 is located next to handle 114. The indentation 132 of each faces the other fin gripper 118, allowing fin gripper 118 to slide around the fin to engage it. In some preferred embodiments, the second fin gripper 118 has a tab 136 extending from its upper portion 134 in the direction of the first fin gripper 118, providing greater stability when engaging a surfboard fin. Moreover, the tab 136 is particularly, but not exclusively, useful for opening bottles, such as beverage bottles containing beer or soda.

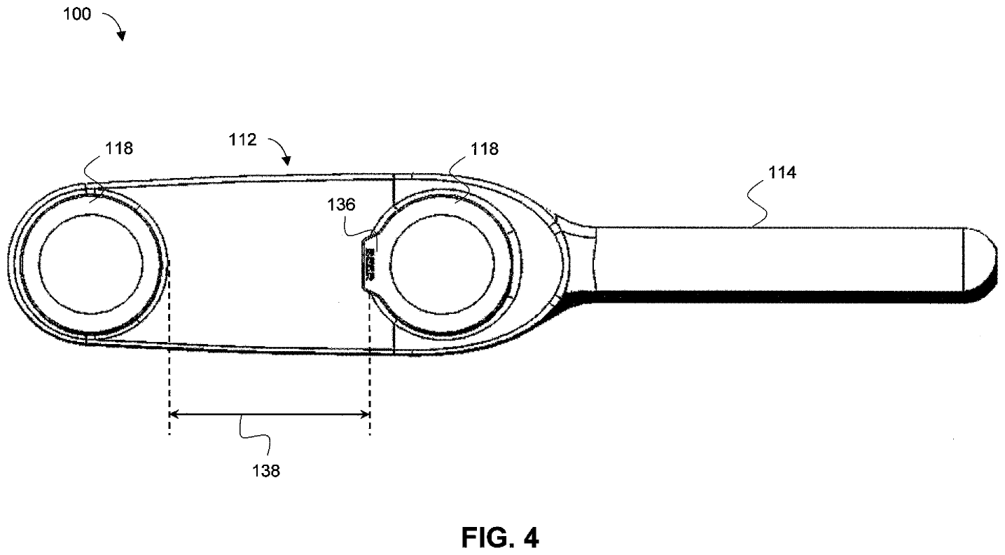

Referring now to FIG. 4, a rear view of the alternate preferred embodiment of tool 100 is illustrated, showing the positions and orientation of fin grippers 118 of fin removal tool 112. As illustrated, fin grippers 118 are located on opposing ends of fin removal tool 112 and spaced apart by distance 138. Distance 138 is selected in order to allow fin grippers 118 to slide around a surfboard fin and engage it as illustrated further in FIG. 5; in a preferred embodiment, distance 138 is approximately one hundred (100) millimeters in order to allow fin removal tool 112 to receive and perform its function with most standard surfboard fins.

Referring now to FIG. 5, tool 100 is illustrated in use with an exemplary surfboard 200 with fin 202. More particularly, fin removal tool 112 is particularly useful for facilitating the removal of fin 202 from surfboard 200. If fin 202 is screwed into surfboard 200, then the fin key 122 or screwdriver from handle 114 is first use to remove the screw that fastens fin 202 to surfboard 200. Once the screw, if present, is removed, fin removal tool 112 is positioned to engage fin 202 with its fin grippers 118, as illustrated in FIG. 5. Tool 100 is then rotated as illustrated by directional arrow 140, causing fin 202 to pivot and snap out of the trailing edge (not shown in FIG. 5) of fin box (not shown in FIG. 5) of surfboard 200. Fin 202 is then pulled completely out of surfboard 200, and surfboard 200 is ready for insertion of another fin, or of the same fin 202 after cleaning or repair.

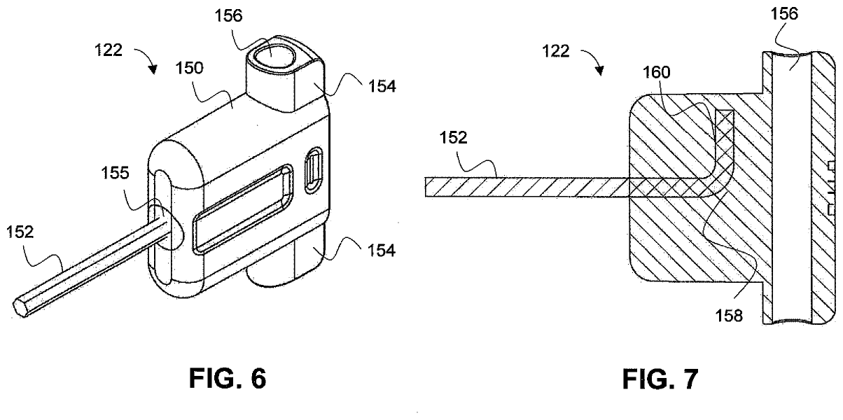

Referring now to FIG. 6, a preferred embodiment of fin key 122 is illustrated. Fin key 122 has a body 150 and a driver tool 152. In preferred embodiments, body 150 is made of seventy percent (70%) recycled propylene and thirty percent (30%) glass fiber, or approximately those quantities. In some embodiments, the driver tool 152 itself is made entirely of propylene. Body 150 has a tab 154 on each side of the opposite end from driver tool 152. Tabs 154 are shaped, in connection with the shape of aperture 120 of handle 114 (see FIG. 2), so that fin key 122 snaps into place when fully inserted into handle 114. In a preferred embodiment, fin key 122 has a straight-through cylindrical aperture 156 extending from one tab 154 to the other tab 154. This aperture is approximately five (5) millimeters in diameter in a preferred embodiment, allowing the preferred embodiment of nylon cord 124 to be passed through, as illustrated in FIG. 2.

In preferred embodiments, driver tool 152 is a fin key or a hex key driver, and fin key 122 is replaceable with other removable tools of the same design except for another driver, such as a flathead (or “slot”) screwdriver or a Phillips driver, so that a user can carry the specific desired removable tool as part of tool 100. In some preferred embodiments, driver tool 152 is part of a removable insert 155, allowing it to be replaced in fin key 122 with another driver tool 152. Thus, a user might have a fin key driver tool 152, a flat-head screw driver tool 152, and a Phillips-head screw driver tool 152 that are interchangeable into fin key 122 as desired.

Referring now to FIG. 7, a diagram of the internal structure of a preferred embodiment of fin key 122 is illustrated. As illustrated, aperture 156 provides a straight path through body 150 of fin key 122. Driver tool 152 is bent at elbow 158 and terminates in orthogonal member 160 in order to facilitate good overmolding. In other preferred embodiments, a different tool structure, such as knurling, is used for to facilitate a better grip when overmolding.

As mentioned above, in some embodiments driver tool 152 is part of removable insert 155 (see FIG. 6). In some such embodiments, driver tool 152 has the same internal structure as described above, but orthogonal member 160 may be shorter as necessary in view of the size limitations required for it to be molded into removable insert 155.

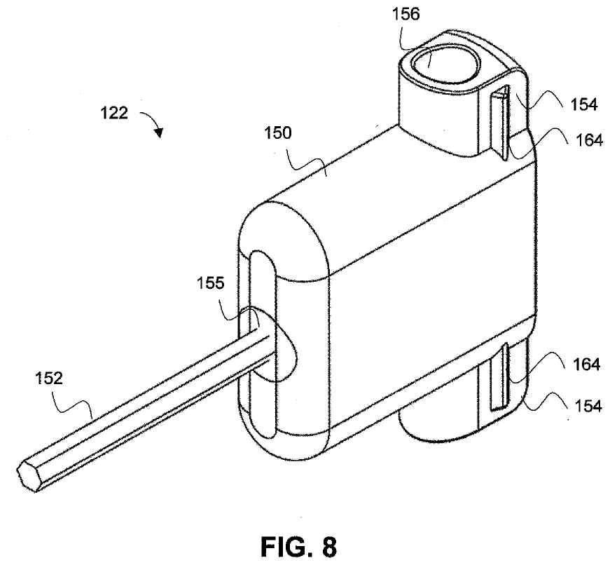

Referring now to FIG. 8, another preferred embodiment of a fin key 122 is illustrated. The embodiment of fin key 122 illustrated is similar in general structure to that of fin key 122 illustrated in FIG. 6, but differs in the generally flat surfaces on the sides of body 150 and the inclusion of tabs 164 on the front and back (not illustrated) of wings 154. Tabs 164 facilitate snapping fin key 122 in place into the aperture 120 of handle 114.

While there have been shown what are presently considered to be preferred embodiments of the present invention, it will be apparent to those skilled in the art that various changes and modifications can be made herein without departing from the scope and spirit of the invention.

1. A fin removal tool comprising:
a head portion and a handle portion;
wherein said head portion has a top side and a bottom side,
wherein said top side has a first fin gripper located at the proximal end of said top side and a second fin gripper located some distance opposite of said first fin gripper, and
wherein said bottom side has a brush.

2. The fin removal tool of claim 1 further comprising a fin key that is removably coupled to the distal end of said handle.

3. The fin removal tool of claim 1 wherein said first fin gripper and said second fin gripper are cylindrically shaped.

4. The fin removal tool of claim 3 wherein said first fin gripper and second fin gripper further comprises an indentation located in the middle of said first and second fin gripper.

5. The fin removal tool of claim 4 wherein said first fin gripper and said second fin gripper are spaced 100 mm apart.

6. The fin removal tool of claim 5 wherein said second fin gripper further comprises a tab.

7. A fin removal tool comprising:
a head portion and a handle portion;
wherein said head portion has a top side and a bottom side,
wherein said top side has a first cylindrically shaped fin gripper located at the proximal end of said head portion and a second cylindrically shaped fin gripper located at some distance opposite of said first cylindrically shaped fin gripper,
wherein said bottom side has a brush, and
wherein said handle portion has an aperture to fit a removably coupled fin key.

8. The fin removal tool of claim 7 wherein said fin key further comprises a body and a driver tool.

9. The fin removal tool of claim 8 wherein said body further comprises an aperture that runs through one side of said body to the opposite side of said body and located at the distal end of said fin key.

10. The fin removal tool of claim 8 wherein said driver tool is a hex key driver.

11. The fin removal tool of claim 9 wherein said aperture is 5 mm in diameter.

12. The fin removal tool of claim 11 wherein said aperture has a nylon cord that runs through it.
